(19) United States
(12) Patent Application Publication
(10) Pub. No.: US 2015/0164749 A1
(43) Pub. Date: Jun. 18, 2015

(54) MATURATIVE GUIDING PACIFIER FOR BABY

(71) Applicant: ORTHOGLOBAL SÀRL, Renens (CH)

(72) Inventor: Michel Lacroix, Yverdon-les-Bains (CH)

(21) Appl. No.: 14/408,032

(22) PCT Filed: Jun. 20, 2013
(86) PCT No.: PCT/EP2013/062929

§ 371 Date: Dec. 15, 2014

(30) Foreign Application Priority Data
Jun. 20, 2012 (CH) 00862/12

(51) Int. Cl. A61J 17/00

(52) U.S. Cl. CPC A61J 17/00; A61J 2017/001

(57) ABSTRACT

The present invention relates to pacifiers for new born children, and more particularly to a maturative guiding pacifier for baby comprising an intra-oral part comprising a nipple; a shield for preventing the baby from swallowing said maturative guiding pacifier; and a connecting part connecting the nipple to the shield. The maturative guiding pacifier is configured to guide, stimulate and facilitate the neuromuscular maturation process of the jaws, the dentition and the face of the baby in its earliest steps after birth. To this end, the nipple comprises a central hole to allow the baby's tongue to contact the palatal mucosa, and the connecting part comprises a transversal elongated aperture to allow the baby's upper and lower lips to come into contact.

### FIELD OF THE INVENTION

The present invention relates to pacifiers for new born children, therefore the present invention relates to the field of baby care and wellness.

### BACKGROUND OF THE INVENTION

There are many types of infant pacifiers available. All pacifiers have a nipple on which an infant can suck and/or bite, a mouth shield to prevent the infant from ingesting the pacifier, and a handle to give the infant a convenient structure for gripping or holding the pacifier. Typically, pacifiers are made of multiple components and/or formed as an integral unit. Pacifiers made of multiple components generally have a flexible nipple surrounded by a rigid mouth shield. The nipple typically passes through an aperture in the center of the mouth shield, creating a sharp corner, and sometimes a crevice, between the shield and the shaft of the nipple where saliva, dirt and the like can accumulate. It is sometimes difficult to keep this type of pacifier clean. Additionally, certain issues regarding safety may arise with this type of pacifier.

Integrally formed pacifiers are typically made of a plastic selected to provide the nipple with the desired flexibility and the mouth shield and handle with the necessary rigidity. Generally, the selection of plastic is governed by the need to provide a relatively rigid mount shield and handle. The nipple, therefore, is usually more rigid than desired.

However, all the existing pacifiers on the market have the same following negative points:
They maintain the sucking infantile habit longer than normal maturation of the neuromuscular system for swallowing. This was confirmed by the recent works about the neuromuscular engramming (recording) system. After recent studies about neuromuscular engramming and maturation of the complex mouth closure on one hand, and the nasal airway functional leading role on other hand, (see: Gérard Couly: Développement céphalique: embryologie, croissance, pathologie. Ed. CDP 1991) http://www.dentalespace.com/dentiste/formation/394-guide-pour-prevention-effets-nocifs-sucettes-sur-position-dents.html), it was evidenced that the neuromuscular maturative process is proceeding step by step, slice by slice, and the use of every common pacifier or dummy block the recording of the following fundamental steps:
   closure of the lips;
   start of normal work of the nasal entry muscular system;
   recognition of the spatial localization of the both jaws relationship;
   recognition for the tongue of the frontal closure and limit between internal and external space.

It is the first step for the tongue to be able to raise up against the palate and stimulate its growing in width by correct pressure at every swallowing (more than 2 000 times/24 h.) If the recognition and the recording of the correct spatial contact between the upper and lower gum is disturbed by the permanent passage of the tongue, this tongue will disturb the correct meeting of the lower and upper milk incisors, and actually, it is a mistake to say that the child can wait for the adult incisors (7 years old) to stop the sucking and to recover the normal occlusion.
They disturb the normal front contact between the lips on one part and the gums on another part (see below new data and recommendations for the use of pacifiers as well as their major inconvenient: http://www.ncbi.nlm.nih.gov/pmc/articles/PMC2791561/?log$=activity). They avoid the maturative contact and closure of the lips and of the frontal, central part of the gums. The closure and correct muscular training of the lips is the first step to allow a normal implementation of the nasal night ventilation. The fundamental role of the night-nasal ventilation is to allow a correct thermo-ventilation of the venous blood of the frontal lobe area. If the upper lip doesn't start a normal work, and remain atonic, the muscle structure of nostrils cannot start working normally and the correct nasal function is disturbed.
They facilitate the deformation of the palate and the discrepancy between both future dental arches. There is an association between those two first points, as correct position of the tongue, stuck at the top to the palate, during the night-sleep, (period of more intense production of the growth hormone) supports this one to allow its expansion, in answer to the received stimulations permanently, from the bottom by the vertical pressures of the tongue at every gulp, and from the top by the stimulations in width of the nostrils muscle structure in every nasal double stimulation by inspiration-expiration. In summary, the disturbance of the first stages of the complex mechanism of a good balance between lips, cheeks outside and tongue inside, and teeth in the middle, is going to strengthen the delay and the disturbance of the whole physiology and oro-dental morphology.

Furthermore, the mandatory minimum conditions for a truly orthodontic pacifier are given at the following link: http://www.orthodontie-fr.com/modules/news/article.php?storyid=47&page=4 As said on this website: http://www.dentalespace.com/dentiste/formation/394-guide-pour-prevention-effets-nocifs-sucettes-sur-position-dents.html, “the ideal pacifier does not exist for the moment on the market and it is necessary to notice that the lack of legal framework concerning the function of the pacifiers leads to a major lack of innovation in the sector. Given that there is no constraint of result, the industrialists invest only too little in the research. Nobody made the approach ask to a scientist to draw the ideal pacifier on a white sheet. At the very moment when these industries are prosperous held by the increasing born number every year. Furthermore, the lack of legislative constraints is dangerous because it inhibits the will of innovation of young creators in a sector dominated by big industrial groups”.

DE 102004031106 describes a baby's dummy or comforter (1) has a nipple (3) for sucking and a carrier (5) which supports the nipple and at least one stopper (7) to prevent swallowing it. The carrier has curvatures (31,33) to take the upper and lower teeth and gums. The stopper has an under bite and/or an over bite (11) with an impression (35). The dummy has a grip ring (21) or a button. The carrier can be at least partially of an elastomer, an elastic or inelastic plastics, a metal, rubber, or latex.

U.S. Pat. No. 3,924,621 (Cassimally) describes an orthodontic device including a baglet, insertable into the mouth of an infant, joined by a plurality of connecting members with a base for preventing further insertion of the device into the infant's mouth. The spaced connecting members define therebetween a central aperture which acts as a guide for the infant's tongue. When the orthodontic device is formed as an exercizer or pacifier, the base is in the form of a mouth shield or guard which has attached to the rear thereof a ring. When the orthodontic device is formed as a milk delivery nipple, the base comprises a hollow retaining cap having a lip for sealing engagement with the neck of a milk bottle. The plurality of connecting members are hollow and define milk delivery channels for connecting the retaining cap to the baglet, which is hollow and has a milk delivery orifice at the mouth entering end.

In order to avoid frontal malocclusion and the resultant jaw anomalies, the dummy teat according to DE3247074 has a shield plate (1) curved in the ideal shape of the jaw, on which the sucking projection (5) is fastened rigidly or so as to be rotatable to a limited extent via a wire coated with a synthetic resin or rubber. The bracket (4) is arranged such that it comes to rest in the gap between the deciduous canine teeth and the deciduous molars, so that the front teeth rest on top of each other even when the dummy teat is used and can thus grow with the correct overbite.

Thus there is still a need to help the baby, as soon as possible (from 1 month to 2 years), to develop a normal neural recording and balanced function of the buccal and facial physio-development.

### SUMMARY OF THE INVENTION

Therefore, an object of the present invention is to provide a new model of pacifier with separate fields for the tongue, the gums and future teeth, and the lips, allowing a correct positioning and correct neuromuscular programming and maturation. As well as avoiding all the negative points permanently discussed above.

This goal is achieved by a maturative guiding pacifier for baby comprising an intra-oral part comprising a nipple; a shield for preventing the baby from swallowing said maturative guiding pacifier; and a connecting part connecting the nipple to the shield. The maturative guiding pacifier is configured to guide, stimulate and facilitate the neuromuscular maturation process of the jaws, the dentition and the face of the baby in its earliest steps after birth. To this end, the nipple comprises a central hole to allow the baby's tongue to contact the palatal mucosa, and the connecting part comprises a transversal elongated aperture to allow the baby's upper and lower lips to come into contact.

The maturative guiding pacifier according to the invention is based on the following three aspects:
the lips must joint, to help nose breathing and initiate the process to a mature deglutition,
the gums must joint and work together to improve their superabundant internal corpuscles of Paccini, which are baroreceptors introducing a balanced relationship in

the three directions of space, between upper and lower dental arches by protraction of the mandible,
the tongue must find its new place against the palate and the cognition procedures will be so facilitated.

Other objects of the invention will appear in the appended description.

### BRIEF DESCRIPTION OF THE FIGURES

FIG. 1 A illustrates the pacifier of the invention and various elements thereof placed in the mouth according to the opposite plan.

FIG. 1B shows the pacifier of the invention viewed lateral section with the three original spaces for muscular connections and neural records.

FIG. 1C shows the pacifier of the invention viewed lateral section with the different components separating the guiding spaces.

FIG. 2 shows the pacifier of the invention from the upper view (seen from the top).

FIG. 3 shows the pacifier of the invention viewed from the lingual side.

FIG. 4 shows the pacifier of the invention from outside.

### DETAILED DESCRIPTION OF THE INVENTION

Although methods and materials similar or equivalent to those described herein can be used in the practice or testing of the present invention, suitable methods and materials are described below. All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

In the case of conflict, the present specification, including definitions, will control. Unless defined otherwise, all technical and scientific terms used herein have the same meaning as is commonly understood by one of skill in art to which the subject matter herein belongs. As used herein, the following definitions are supplied in order to facilitate the understanding of the present invention.

As used herein, the following definitions are supplied in order to facilitate the understanding of the present invention.

As herein used, “a” or “an” means “at least one” or “one or more.”

The term “comprise” is generally used in the sense of include, that is to say permitting the presence of one or more features or components.

The terms “maturative guiding pacifier” correspond to the fact that this device will help each actor of the physiologic development of the mouth and the lower face (lips_tongue_gums and teeth) to enter in function and to grow in a normal balanced relationship with the other parts, following a gradual process: the lips against the lips—the tongue against the palate—the gums against the gums.

An object of the present invention is to provide a maturative guiding pacifier for baby comprising:
an intra-oral part comprising a nipple (1),
an extra-oral part comprising a shield (5) for preventing the baby from swallowing said maturative guiding pacifier,
a connecting part (3) connecting the nipple (1) to the shield (5),
wherein
the nipple comprises a central hole (ch) to allow the baby's tongue to contact the palatal mucosa, and
the connecting part (3) comprises a transversal elongated aperture to allow the baby's upper and lower lips to come into contact.

In a preferred embodiment of the invention, the transversal elongated aperture of the connecting part (3) of the maturative guiding pacifier is formed by a double elongated member (3′) connecting said nipple (1) to said shield (5).

In a further embodiment, the double elongated member (3′) is in the form of a U-shape with two lateral arms defining a cavity to accommodate the baby's upper and lower lips, wherein the double elongated member (3′) connecting said nipple (1) to said shield (5) is preferably a rigid arm.

In a preferred embodiment, the intra-oral part comprises a guiding groove (2)-(4) for the gums and first incisors coming, with an internal protuberance (2) separating the tongue from the gums for stimulating the mandible (mandibular) protraction.

In another embodiment, the guiding groove (2)-(4) comprises a bite plane (bp) for tightening and biting and an external protuberance (4) separating the gums from the lips.

In a further embodiment the double elongated member (3′) comprises a safety inclusion (Y) in the lingual shield. Preferably the safety inclusion (Y) located in the guiding groove is round and curved. In a particular embodiment of the invention this safety inclusion (Y) may look like a snap wherein its female part, piece of the connecting part 3, is clipped as a clasp button on the inside (side of the tongue) i.e. “nipple+bite plane” (1+4).

In case of tractions to separate the intra-oral part (nipple) of the extra-oral part, the elements (3+Y) and (1+4) are secured so as to resist such as two links of a chain. Other linking systems for the safety inclusion (Y) may be envisioned by a skilled in the art such as hooks or hasps or any other means providing a safe, resistant and strong linkage.

In a preferred embodiment, the nipple (1) is round in its width and flat in his thickness, and is preferably made of two waterproof leaves, separated by a coat of air, to remain supple and mobile under the pressures of the tongue.

In another object of the invention, the maturative guiding pacifier comprises an external handle (7) connected to the connecting part (3).

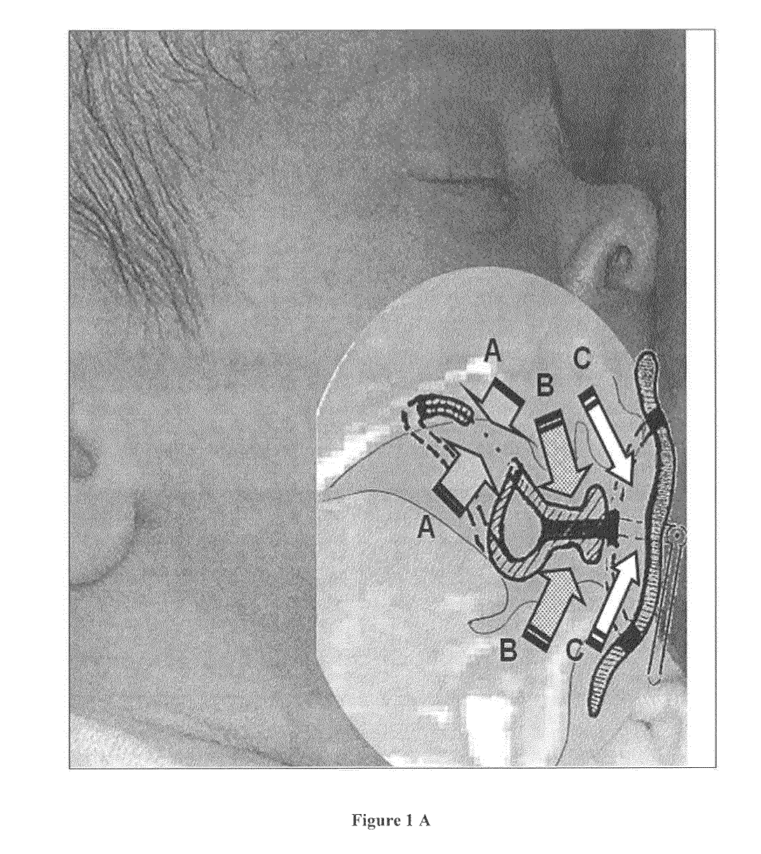

The present invention obeys a totally different concept to propose a solution of every stage of the development of the various concerned parts. FIGS. 1A and 1B show the pacifier of the invention according to the opposite plan:
the lingual space inside (A),
the corridor for the junction of gums and coming incisors in the middle (B),
and the space for the junction of lips outside (C),

Every space so reserved is separated from the following one by a guiding mean (or form): an internal protuberance (2) between tongue inside and gums and coming teeth outside an external protuberance (4) between gums and teeth inside and the lips outside

Therefore the present invention avoids all the common harmful effects of all the available models, and more still: this pacifier helps for the first steps of the normal physiologic maturative process of the mouth and of the nose breathing. Furthermore, the maturative guiding pacifier for baby according to the present invention is adapted for the neural recording useful spatial cues so as to complete the body schema.

The present invention may be for example declined in two versions, with increasing dimensions, according to the stages of development of the dental arches (model 1: from 0 to 4 teeth—model 2: from 4 to complete milk dentition) The pacifier of the invention may be described in two parts an intra-oral part and an extra-oral part, limited by the lips, from inside to outside: (see also FIGS. 1A-1C).

### Intra-Oral Part (FIG. 1C):

The nipple (1), with a particular shape, an internal protuberant ring (2) on the lower side, helps the new born child to separate and autonomize the neuromuscular impulses of the tongue from the ones of the gums and the lips as said below for the external protuberance (4). In particular In particular this internal protuberant shape (2) helps the protrusion of the mandible, the lower jaw, to seize and hold the nipple (1). This nipple comprises a central hole (ch) to activate the neurosensitive contacts and auto recognition by the tongue touching the palatal mucosa. Elements (2)-(4) are the guiding groove for the gums and first incisors coming, with an internal protuberance or edge (2) separating the tongue from the gums, with a tray for tightening and biting (4) also defined as the external protuberance separating the gums from the lips.

The external protuberance (4) is like a “recording contactor” for the frontal part (canine to canine included) of the gums, what we call “incisivo-canine arch”. This part contains much more Golgi corpuscles, than the rest of the gum, (see publications of Gerard Couly) and this part is the first step to react and record the pressures of both future dental arches together.

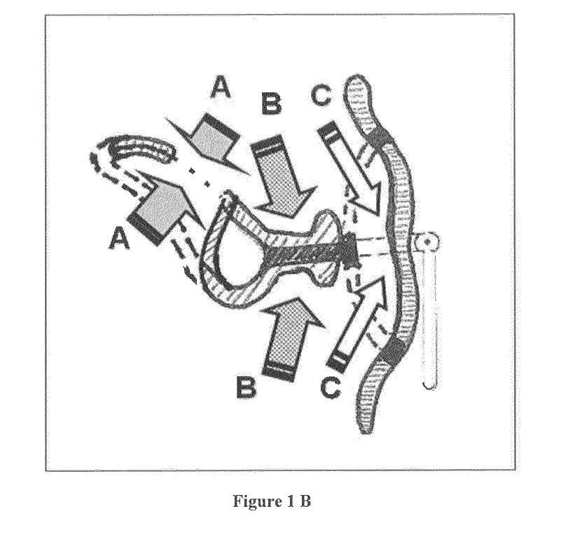

### Extra-Oral Part (FIG. 2):

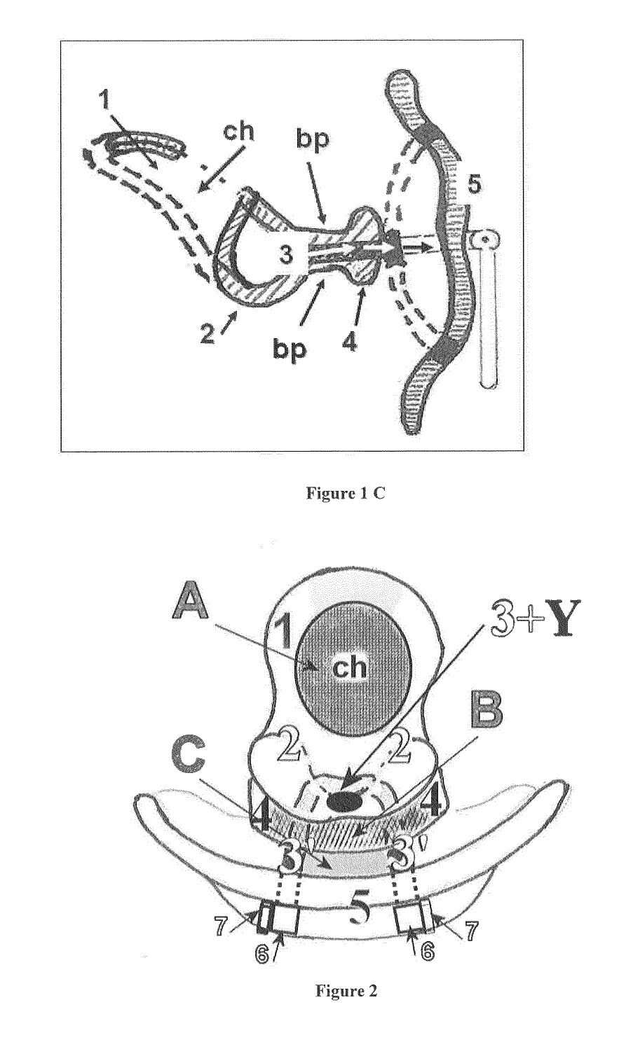

Element (5) corresponds to the external shield and (3′) to a double elongated member (or arm) corresponding to the extra-resistant system of connection between both parts, with a safety inclusion in the lingual shield (Y) (see FIG. 3).

This is an important aspect of the present invention as the double elongated member (3′) (corresponding to 2 symmetric links for example in a U shape) allows the central contact and neuromuscular recording of the lips (first) and gums (second).

All these components of the intra-oral part, nipple (1) and guiding groove (2)-(4) as well as the connecting part (3) are made together in one part for example with a very soft silicone of medical quality.

The nipple (1) is generally round in its width, empty in its center, but flat in his thickness, looking like a ring, preferably made by 2 waterproof leaves, separated by a coat of air, to remain supple and mobile, as a pillow, under the pressures of the tongue.

The bite plane (bp) limited by the internal protuberance (2) of the nipple and the external protuberance (4) is strong enough to resist to the first biting forces of the two first coming incisors.

This bite plane bp and the guiding groove (2)-(4) contain the connecting member (3), extra-resistant link (6), with the external shield (5).

Also provided is an external handle (7) and means for linking the handle namely the extra-resistant link (6).

The both external and internal protuberances (2)+(4) or guiding groove of the intra-oral part are designed with a central curve to reduce the vertical dimension and respect the eventuality of a big tongue frenum or external lip frenum.

The connecting member (3) between both parts (intra- and extra-oral) is made in one part with the external safety shield, and both are made for example in strong propylene plastic. From inside to outside, there is a round and curved safety inclusion (Y) in the guiding groove, the double elongated member (3′) or links going outside to the external shield, so that the lips can join in the center without any opposition. This double elongated member (3′) is continuing with the complete external shield (5) preferably having a very light design and most preferably several hole to have a very light weight (see FIGS. 3 & 4).

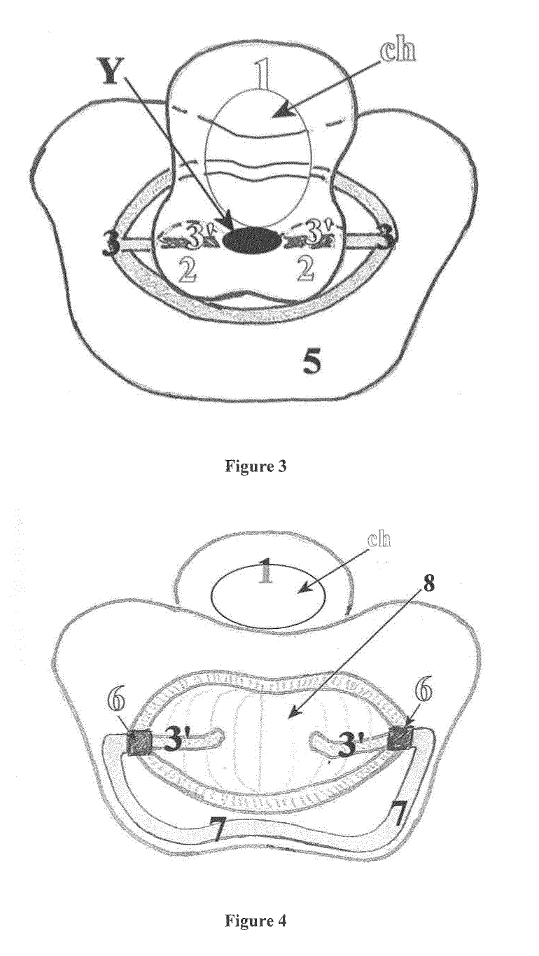

The design of this external shield (5) follows the protuberant relief of the lips (see 8 on FIG. 4). So the lips are not anymore stressed against the face, as with the usual models, and they can close and move and develop without any frontal compression.

The Intra-oral part (1)+(2)+(4) are preferably made of soft silicone of medical quality, whereas the Extra-oral part (5)+(3) are preferably made of propylene plastic.

Preferably the material composing the pacifier of the invention is made according to the usual norms:

EN Standard 1400; U.S. Consumer Product Safety Commission Requirements for Pacifiers (16 C.F.R. Part 1511) as well as the European coming new norms.

Those skilled in the art will appreciate that the invention described herein is susceptible to variations and modifications other than those specifically described. It is to be understood that the invention includes all such variations and modifications without departing from the spirit or essential characteristics thereof. The invention also includes all of the steps, features, compositions and compounds referred to or indicated in this specification, individually or collectively, and any and all combinations or any two or more of said steps or features. The present disclosure is therefore to be considered as in all aspects illustrated and not restrictive, the scope of the invention being indicated by the appended Claims, and all changes which come within the meaning and range of equivalency are intended to be embraced therein.

1. A maturative guiding pacifier for baby comprising:
an intra-oral part comprising a nipple,
an extra-oral part comprising a shield for preventing the baby from swallowing said maturative guiding pacifier,
a connecting part connecting the nipple to the shield, wherein
the nipple comprises a central hole to allow the baby's tongue to contact the palatal mucosa, and
the connecting part comprises a transversal elongated aperture to allow the baby's upper and lower lips to come into contact.

2. The maturative guiding pacifier according to claim 1, wherein the transversal elongated aperture of the connecting part is formed by a double elongated member connecting said nipple to said shield.

3. The maturative guiding pacifier according to claim 2, wherein said double elongated member is in the form of a U-shape with two lateral arms defining a cavity to accommodate the baby's upper and lower lips.

4. The maturative guiding pacifier according to claim 2, wherein said double elongated member connecting said nipple to said shield is a rigid arm.

5. The maturative guiding pacifier according to any one of the claim 1, wherein said intra-oral part further comprises a guiding groove for the gums and first incisors coming, with an internal protuberance separating the tongue from the gums for stimulating the mandible protraction.

6. The maturative guiding pacifier according to claim 5, wherein the guiding groove comprises a bite plane for tightening and biting and an external protuberance separating the gums from the lips.

7. The maturative guiding pacifier according to claim 2, wherein said double elongated member comprises a safety inclusion in the lingual shield.

8. The maturative guiding pacifier according to claim 1, wherein the nipple is round in its width and flat in his thickness, said nipple is made by 2 waterproof leaves, separated by a coat of air, to remain supple and mobile under the pressures of the tongue.

9. The maturative guiding pacifier according to claim 1, comprising an external handle connected to the connecting part.
